(19) United States
(12) Patent Application Publication
(10) Pub. No.: US 2018/0218405 A1
(43) Pub. Date: Aug. 2, 2018

(54) CONTENT SOURCE SUGGESTION SYSTEM

(71) Applicant: Google Inc., Mountain View, CA (US)

(72) Inventors: Justin Lewis, Marina Del Rey, CA (US); Gavin James, Los Angeles, CA (US)

(21) Appl. No.: 14/327,770

(22) Filed: Jul. 10, 2014

(51) Int. Cl. G06Q 30/02

(52) U.S. Cl. CPC G06Q 30/0269

(57) ABSTRACT

Systems and method for generating suggested content sources for a subject content provider may include accessing a set of impression data for similar third-party content providers or categories of content providers clustered with a subject content provider and determining an ordered suggested content source set based on the accessed impression data for the similar third-party content providers or categories of content providers. The ordered suggested content source set may be presented to the subject content provider, such as through an interface, for selection by the subject content provider to direct content items to be selected and served with the content of the content source.

### BACKGROUND

In a networked environment, such as the Internet or other networks, first-party content providers can provide information for public presentation on resources, for example webpages, documents, applications, and/or other resources. The first-party content can include text, video, and/or audio information provided by the first-party content providers via, for example, a resource server for presentation on a client device over the Internet. The first-party content may be a webpage requested by the client device or a stand-alone application (e.g., a video game, a chat program, etc.) running on the client device. Additional third-party content can also be provided by third-party content providers for presentation on the client device together with the first-party content provided by the first-party content providers. For example, the third-party content may be a public service announcement or advertisement that appears in conjunction with a requested resource, such as a webpage (e.g., a search result webpage from a search engine, a webpage that includes an online article, a webpage of a social networking service, etc.) or with an application (e.g., an advertisement within a game). Thus, a person viewing a resource can access the first-party content that is the subject of the resource as well as the third-party content that may or may not be related to the subject matter of the resource.

### SUMMARY

Implementations described herein relate to generating suggested content sources for a third-party content provider for selection for serving third-party content items. The content source suggestion system may cluster a subject content provider with similar third-party content providers or categories of content providers using various criteria, such as by similar selection criteria for campaigns, similar size of the content providers, similar content item budgets, etc. Using the similar third-party content providers or categories of content providers, a set of impression data may be accessed from an impression database for the similar third-party content providers or categories of content providers. In other instances, the data may be click data, endorsement data, etc. The impression data may be aggregated for each of the similar third-party content providers or categories of content providers for each content source and sorted based on the content source or category of the content source. In some implementations, the content sources of the similar third-party content providers or categories of content providers may be compared to those of the subject content provider to determine a set of content sources that the similar third-party content providers or categories of content providers direct third-party content items to be served to which the subject content provider does not direct content items to be served. The set of content sources may be presented to the subject content provider, such as through an interface, for selection by the subject content provider to direct content items to be selected and served with the content of the content source. In some instances, metrics associated with the similar third-party content providers or categories of content providers for the content source, such as a percentage share of the impressions of content items for the content source, may be presented with the set of content sources via the interface to provide additional context to the subject content provider.

One implementation relates to a method for determining an ordered suggested content source set. The method may include receiving a suggested content source request from a client device. The method may also include accessing impression data for the set of one or more other content providers clustered with a subject content provider and determining a set of content sources based on the accessed impression data for the set of one or more other content providers. The method further includes determining an ordered suggested content source set based on the determined set of content sources and the accessed impression data for the set of one or more other content providers and outputting the ordered suggested content source set to the client for display responsive to the received suggested content source request.

Another implementation relates to a system for determining an ordered suggested content source set. The system may include one or more processors and one or more storage devices. The one or more storage devices include instructions that cause the one or more processors to perform several operations. The operations accessing impression data for a set of one or more other content providers clustered with a subject content provider. The operations further include determining an ordered suggested content source set of content sources based on the accessed impression data for the set of one or more other content providers and outputting the ordered suggested content source set to the client for display.

Yet a further implementation relates to a computer readable storage device storing instructions that, when executed by one or more processors, cause the one or more processors to perform several operations. The operations may include receiving a suggested content source request from a client device and accessing impression data for a set of one or more other content providers clustered with a subject content provider. The operations may also include determining a total aggregate other content provider number of impressions for each content source based on the accessed impression data for the set of one or more other content providers. The operations further include determining an ordered suggested content source set based on the determined total aggregate other content provider number of impressions for each content source and outputting the ordered suggested content source set to the client for display responsive to the received suggested content source request.

### BRIEF DESCRIPTION OF THE DRAWINGS

The details of one or more implementations are set forth in the accompanying drawings and the description below. Other features, aspects, and advantages of the disclosure will become apparent from the description, the drawings, and the claims, in which:

FIG. 1 is an overview depicting an implementation of a system of providing information via a computer network;

FIG. 2 is a block diagram of an implementation of a content item selection system having a content source suggestion system;

FIG. 3 is a process diagram of an implementation of a process for determining an ordered suggested content source set for a subject content provider;

FIG. 4 is an overview of an implementation of an interface for presenting a determined ordered suggested content source set and additional metric information to a subject content provider; and

FIG. 5 is a block diagram depicting a general architecture for a computer system that may be employed to implement various elements of the systems and methods described and illustrated herein.

It will be recognized that some or all of the figures are schematic representations for purposes of illustration. The figures are provided for the purpose of illustrating one or more embodiments with the explicit understanding that they will not be used to limit the scope or the meaning of the claims.

### DETAILED DESCRIPTION

Following below are more detailed descriptions of various concepts related to, and implementations of, methods, apparatuses, and systems for providing information on a computer network. The various concepts introduced above and discussed in greater detail below may be implemented in any of numerous ways as the described concepts are not limited to any particular manner of implementation. Examples of specific implementations and applications are provided primarily for illustrative purposes.

A computing device (e.g., a client device) can view a resource, such as a webpage, a document, an application, etc. In some implementations, the computing device may access the resource via the Internet by communicating with a server, such as a webpage server, corresponding to that resource. The resource includes first-party content that is the subject of the resource from a first-party content provider (i.e., a content source) and may also include additional third-party provided content, such as advertisements or other content. In one implementation, responsive to receiving a request to access a webpage, a webpage server and/or a client device can communicate with a data processing system, such as a content item selection system, to request a content item to be presented with the requested webpage, such as through the execution of code of the resource to request a third-party content item to be presented with the resource. The content item selection system can select a third-party content item and provide data to effect presentation of the content item with the requested webpage on a display of the client device.

The computing device (e.g., a client device) may also be used to view or execute an application, such as a mobile application. The application may include first-party content that is the subject of the application from a first-party content provider (i.e., a content source) and may also include additional third-party provided content, such as advertisements or other content. In one implementation, responsive to use of the application, a resource server and/or a client device can communicate with a data processing system, such as a content item selection system, to request a content item to be presented with a user interface of the application and/or otherwise. The content item selection system can select a third-party content item and provide data to effect presentation of the content item with the application on a display of the client device.

In some instances, a webpage or other resource (such as, for instance, an application) includes one or more content item slots in which a selected and served third-party content item may be displayed. The code (e.g., JavaScript®, HTML, etc.) defining a content item slot for a webpage or other resource may include instructions to request a third-party content item from the content item selection system to be presented with the webpage. In some implementations, the code may include an image request having a content item request URL that may include one or more parameters (e.g., /page/contentitem?devid=abc123&devnfo=A34r0). Such parameters may, in some implementations, be encoded strings such as “devid=abc123” and/or “devnfo=A34r0.”

In some instances, a device identifier may be associated with the client device. The device identifier may be a randomized number associated with the client device to identify the device during subsequent requests for resources and/or content items. In some instances, the device identifier may be configured to store and/or cause the client device to transmit information related to the client device to the content item selection system and/or resource server (e.g., values of sensor data, a web browser type, an operating system, historical resource requests, historical content item requests, etc.).

In situations in which the systems discussed here collect personal information about users, or may make use of personal information, the users may be provided with an opportunity to control whether programs or features collect user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For instance, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content server.

A third-party content provider, when providing third-party content items for presentation with requested resources via the Internet or other network, may utilize a content item management service to control or otherwise influence the selection and serving of the third-party content items. For instance, a third-party content provider may specify selection criteria (such as keywords) and corresponding bid values that are used in the selection of the third-party content items. The bid values may be utilized by the content item selection system in an auction to select and serve content items for presentation with a resource. For instance, a third-party content provider may place a bid in the auction that corresponds to an agreement to pay a certain amount of money if a user interacts with the provider's content item (e.g., the provider agrees to pay $3 if a user clicks on the provider's content item). In other instances, a third-party content provider may place a bid in the auction that corresponds to an agreement to pay a certain amount of money if the content item is selected and served (e.g., the provider agrees to pay $0.005 each time a content item is selected and served or the provider agrees to pay $0.05 each time a content item is selected or clicked). In some instances, the content item selection system uses content item interaction data to determine the performance of the third-party content provider's content items. For instance, users may be more inclined to click on third-party content items on certain webpages over others. Accordingly, auction bids to place the third-party content items may be higher for high-performing webpages, categories of webpages, and/or other criteria, while the bids may be lower for low-performing webpages, categories of webpages, and/or other criteria.

In other instances, a third-party content provider may specify certain resources and/or content sources with which to present a content item. For instance, a third-party content provider may specify a specific website for a content item to be selected and served. Such direct placement of content items with content sources may benefit a third-party content provider by serving content items only with resources that are viewed by persons that may be interested in the served content item.

Once a third-party content item is selected by the content item selection system, data to effect presentation of the third-party content item on a display of the client device may be provided to the client device using a network.

Efficiently presenting content items with relevant resources of content sources to receptive users benefits all parties by reducing unwanted or irrelevant content items being displayed to uninterested users. The third-party content provider receives useful impressions and/or clicks for a content item, the user receives relevant content items that may pique their interest, and the content source receives greater revenue based on the higher likelihood of a conversion. Thus, it may be useful to automatically detect and suggest high quality content source opportunities for a content provider. In some instances, such content source opportunities may be identified based on the subject matter of the resources of the content source, such as keywords, products, services, etc. In other instances, content source opportunities may be identified based on categories for the resource of the content sources, such as the categories organized by a search engine, a content source self-identified categories, etc. While such methods of identifying content source opportunities for a content provider may be useful, in some instances other content providers may identify and utilize different content sources for selecting and serving content items. Moreover, it may be useful to provide metrics with the identified content source opportunities to allow a subject content provider to determine which identified content source opportunities may be worth pursuing.

A content source may include media providers (e.g., a video provider, a provider of a collection of videos, a provider of audio, a podcast, an image provider, a provider of a collection of images, etc.), a mobile application provider or developer, a web page or website, or a combination thereof. Content sources may have a brand identity that is unique to that content source. The stronger the brand identity, the more likely the content source will have engaged users. In some instances, content sources may be owned and managed by other parties (e.g., an individual's media channel, etc.), and the content sources may have a measurable amount of sustained traffic such that displaying content items with the content of the content source are displayed to this traffic. Accordingly, suggesting content sources with sustained traffic may improve the number of impressions and/or conversions a content provider receives for various content items.

Identification of content source opportunities based on data about other content providers may include analyzing the distribution of impressions among other content providers for particular content sources and/or clusters of content sources. Other implementations may include actual traffic (e.g., clicks or organic traffic) as a metric instead of impressions. In other implementations, user engagement or endorsement for particular content items (such as “likes” or “+1” s) might be used as a metric as well. In some implementations, these various metrics may be combined into either a summary statistic for simplification or generalized score to obscure content provider data.

In some implementations, a process may determine a set of similar third-party content providers or categories of content providers for a subject content provider. The set of similar third-party content providers or categories of content providers may be determined based on sharing a similar set of direct placement content source impressions (e.g., sharing similar direct placement content sources), sharing a similar set of selection criteria, sharing a similar category, etc. The process may utilize clustering mechanisms to group a subject content provider with other similar third-party content providers or categories of content providers. For instance, a K-nearest-neighbor (KNN) algorithm may be implemented to cluster a subject content provider with similar third-party content providers or categories of content providers. In other implementations, K-means clustering, hierarchical agglomerative clustering algorithms, and/or other clustering algorithms may be used. The clusters may be generated based on the set of direct placement content sources, direct placement content source impressions for each content source, similar sets of selection criteria, similar categories, etc. In some implementations, the set of direct placement content source impressions for each content source might be limited to those for content sources that a similar third-party content provider manually or specifically selected or could include content sources that were selected based on broader selection criteria (such as an automated categorical or demographic driven system). In some implementations, the clustering may be performed as an offline background process to cluster a subject content provider with similar third-party content providers or categories of content providers. In some implementations, the similar third-party content providers or categories of content providers may be filtered based on entity size, content item purchase size, actual traffic, etc. to limit the set of similar third-party content providers or categories of content providers.

In some implementations, the determined set of similar third-party content providers or categories of content providers for a subject content provider may be associated with the subject content provider and stored for retrieval at a later time. For instance, the determined set of similar third-party content providers or categories of content providers may be associated with a cluster identifier that uniquely identifies the clustered similar third-party content providers or categories of content providers. One of more cluster identifiers may be associated with the subject content provider and may be retrieved responsive to a request to provide suggested content sources. Thus, the one or more cluster identifiers for a subject content provider may be retrieved and used to identify the set of similar third-party content providers or categories of content providers determined by the clustering process described herein.

The total number of impressions, traffic (e.g., clicks or organic traffic), or user engagement/endorsement generated for each of the similar third-party content providers or categories of content providers on each of the potential content sources may be determined. In some implementations, the content sources that a subject content provider is already directly placing content items on may be excluded. In some implementations, the total number of impressions, traffic (e.g., clicks or organic traffic), or user engagement/endorsement generated for the subject content provider for each of the content sources may be determined such that a percentage share of an aggregate number of impressions, traffic (e.g., clicks or organic traffic), or user engagement/endorsement may be determined for the subject content provider and/or the similar third-party content providers or categories of content providers. That is, a subject content provider may only have a limited shared (e.g., <1%) of the impressions for a content source due to selection criteria and not direct placement. If similar third-party content providers or categories of content providers have a greater share, then the subject content provider may be interested in increasing their share of the impressions via direct placement of content items with the content source. In other instances, the percentage share for the similar third-party content providers or categories of content providers may be included as additional data to be considered by a subject content provider.

An ordered suggested content source set may be generated based on the total number of impressions, traffic (e.g., clicks or organic traffic), or user engagement/endorsement generated for each of the similar third-party content providers or categories of content providers on each of the potential content sources. That is, the content source having the largest number of impressions, traffic, or user engagement/endorsement for similar third-party content providers or categories of content providers may be the first listed content source. The content source having the second largest number of impressions, traffic, or user engagement/endorsement for similar third-party content providers or categories of content providers may be the second listed content source, etc. The ordered suggested content source set may be transmitted responsive to a suggested content source request. In some implementations, the ordered suggested content source set may include additional data associated with each content source of the ordered suggested content source set. For instance, the additional data may include names of one or more similar third-party content providers or categories of content providers and/or a percentage share of the aggregate impressions that the similar third-party content provider or category of content providers received for the content source of the ordered suggest content source set.

The ordered suggested content source set may be transmitted to a client device of a subject content provider for presentation in an interface. For instance, the ordered suggest content source set may be displayed in an interface of a content item management service. In some implementations, the interface may permit a user to select or mouse-over a content source of the ordered suggested content source set to display the additional data.

While the foregoing has provided an overview of determining an ordered suggested content source set, the following provides more details regarding various implementations.

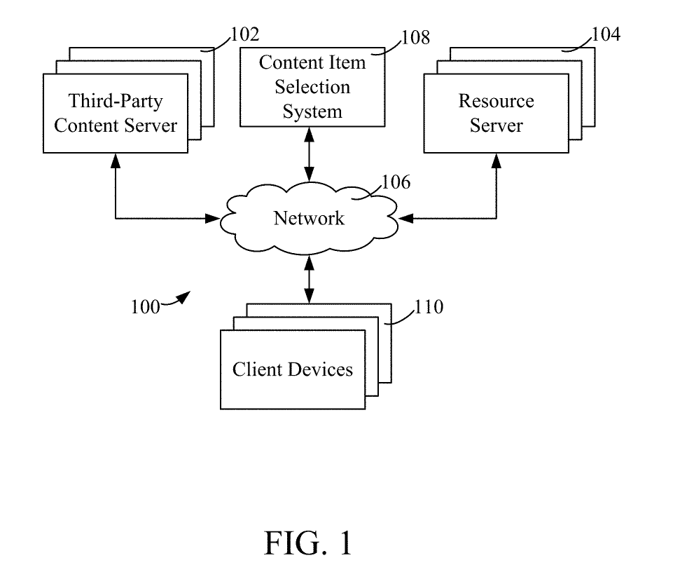

FIG. 1 is a block diagram of an implementation of a system 100 for providing information via at least one computer network such as the network 106. The network 106 may include a local area network (LAN), wide area network (WAN), a telephone network, such as the Public Switched Telephone Network (PSTN), a wireless link, an intranet, the Internet, or combinations thereof. The system 100 can also include at least one data processing system, such as a content item selection system 108. The content item selection system 108 can include at least one logic device, such as a computing device having a data processor, to communicate via the network 106, for instance with a resource server 104 (such as a server hosting content of a content source), a client device 110, and/or a third-party content server 102. The content item selection system 108 can include one or more data processors, such as a content placement processor, configured to execute instructions stored in a memory device to perform one or more operations described herein. In other words, the one or more data processors and the memory device of the content item selection system 108 may form a processing module. The processor may include a microprocessor, an application-specific integrated circuit (ASIC), a field-programmable gate array (FPGA), etc., or combinations thereof. The memory may include, but is not limited to, electronic, optical, magnetic, or any other storage or transmission device capable of providing processor with program instructions. The memory may include a floppy disk, compact disc read-only memory (CD-ROM), digital versatile disc (DVD), magnetic disk, memory chip, read-only memory (ROM), random-access memory (RAM), Electrically Erasable Programmable Read-Only Memory (EEPROM), erasable programmable read only memory (EPROM), flash memory, optical media, or any other suitable memory from which processor can read instructions. The instructions may include code from any suitable computer programming language such as, but not limited to, C, C++, C#, Java®, JavaScript®, Perl®, HTML, XML, Python®, and Visual Basic®. The processor may process instructions and output data to effect presentation of one or more content items to the resource server 104 and/or the client device 110. In addition to the processing circuit, the content item selection system 108 may include one or more databases configured to store data. The content item selection system 108 may also include an interface configured to receive data via the network 106 and to provide data from the content item selection system 108 to any of the other devices on the network 106. The content item selection system 108 can include a server, such as an advertisement server or otherwise.

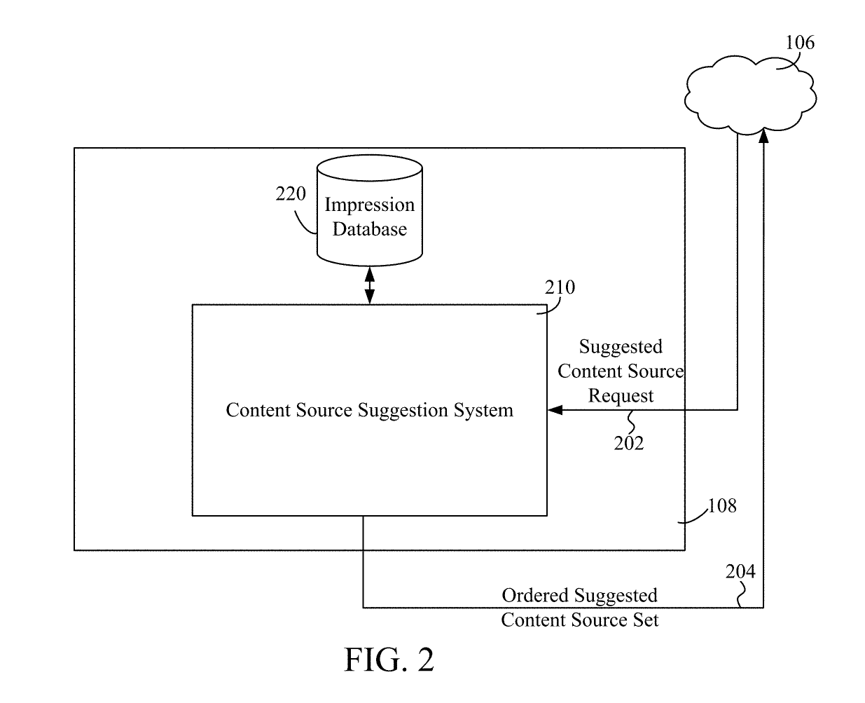

The content item selection system 108 may include a content source suggestion system 210, shown in FIG. 2. In some implementations, the content source suggestion system 210 may part of the same system as the content item selection system 108 or the content source suggestion system 210 may be separate from the content item selection system 108. For instance, the content source suggestion system 210 may be a sub-system of the content item selection system 108 or the content source suggestion system 210 may be a separate system in communication with the content item selection system 108. In implementations where the content source suggestion system 210 is separate from the content item selection system 108, the content source suggestion system 210 may be constructed in a similar manner to the content item selection system 108 described herein. In still further implementations, the content item selection system 108 may be omitted and the content source suggestion system 210 may be connected to the network 106 to communicate with the third-party content server 102, resource server 104, and/or client device 110.

The client device 110 can include one or more devices such as a computer, laptop, desktop, smart phone, tablet, personal digital assistant, set-top box for a television set, a smart television, or server device configured to communicate with other devices via the network 106. The device may be any form of electronic device that includes a data processor and a memory. The memory may store machine instructions that, when executed by a processor, cause the processor to perform one or more of the operations described herein. The memory may also store data to effect presentation of one or more resources, content items, etc. on the computing device. The processor may include a microprocessor, an application-specific integrated circuit (ASIC), a field-programmable gate array (FPGA), etc., or combinations thereof. The memory may include, but is not limited to, electronic, optical, magnetic, or any other storage or transmission device capable of providing processor with program instructions. The memory may include a floppy disk, compact disc read-only memory (CD-ROM), digital versatile disc (DVD), magnetic disk, memory chip, read-only memory (ROM), random-access memory (RAM), Electrically Erasable Programmable Read-Only Memory (EEPROM), erasable programmable read only memory (EPROM), flash memory, optical media, or any other suitable memory from which processor can read instructions. The instructions may include code from any suitable computer programming language such as, but not limited to, ActionScript®, C, C++, C#, HTML, Java®, JavaScript®, Perl®, Python®, Visual Basic®, and XML.

The client device 110 can execute a software application (e.g., a web browser or other application) to retrieve content from other computing devices over network 106. Such an application may be configured to retrieve first-party content from a resource server 104. In some cases, an application running on the client device 110 may itself be first-party content (e.g., a game, a media player, etc.). In one implementation, the client device 110 may execute a web browser application which provides a browser window on a display of the client device. The web browser application that provides the browser window may operate by receiving input of a uniform resource locator (URL), such as a web address, from an input device (e.g., a pointing device, a keyboard, a touch screen, or another form of input device). In response, one or more processors of the client device executing the instructions from the web browser application may request data from another device connected to the network 106 referred to by the URL address (e.g., a resource server 104 hosting content of a content source). The other device may then provide web page data and/or other data to the client device 110, which causes visual indicia to be displayed by the display of the client device 110. Accordingly, the browser window displays the retrieved first-party content, such as web pages from various websites, to facilitate user interaction with the first-party content.

The resource server 104 hosting content of a content source can include a computing device, such as a server, configured to host a resource, such as a web page or other resource (e.g., articles, comment threads, music, video, graphics, search results, information feeds, etc.). The resource server 104 may be a computer server (e.g., a file transfer protocol (FTP) server, file sharing server, web server, etc.) or a combination of servers (e.g., a data center, a cloud computing platform, etc.). The resource server 104 can provide content (e.g., videos, audio, images, text documents, PDF files, and other forms of electronic content) to the client device 110. In one implementation, the client device 110 can access the resource server 104 via the network 106 to request data to effect presentation of content hosted by the resource server 104 of a content source.

One or more third-party content providers may have third-party content servers 102 to directly or indirectly provide data for third-party content items to the content item selection system 108 and/or to other computing devices via network 106. The content items may be in any format that may be presented on a display of a client device 110, for instance, graphical, text, image, audio, video, etc. The content items may also be a combination (hybrid) of the formats. The content items may be banner content items, interstitial content items, pop-up content items, rich media content items, hybrid content items, Flash® content items, cross-domain iframe content items, etc. The content items may also include embedded information such as hyperlinks, metadata, links, machine-executable instructions, annotations, etc. In some instances, the third-party content servers 102 may be integrated into the content item selection system 108 and/or the data for the third-party content items may be stored in a database of the content item selection system 108.

In an implementation, the content item selection system 108 can receive, via the network 106, a request for a content item to present with content of a content source. The received request may be received from a resource server 104 hosting content of a content source, a client device 110, and/or any other computing device. The resource server 104 may be owned or ran by content source or by an entity hosting content for a content source that may include instructions for the content item selection system 108 to provide third-party content items with content of the content source of the resource server 104. The content may include a web page, a website, video content, a collection of video content, audio content, a collection of audio content, a podcast, an image, a collection of images, etc.

The client device 110 may be a computing device operated by a user (represented by a device identifier), which, when accessing content hosted by the resource server 104, can make a request to the content item selection system 108 for content items to be presented with the content, for instance. The content item request can include requesting device information (e.g., a web browser type, an operating system type, one or more previous requests from the requesting device, one or more previous content items received by the requesting device, a language setting for the requesting device, a geographical location of the requesting device, a time of a day at the requesting device, a day of a week at the requesting device, a day of a month at the requesting device, a day of a year at the requesting device, etc.) and content information (e.g., URL of the requested content, one or more keywords of the content, text of the content, a title of the content, a category of the content, a type of the content, etc.). The information that the content item selection system 108 receives can include a HyperText Transfer Protocol (HTTP) cookie which contains a device identifier (e.g., a random number) that represents the client device 110.

In some implementations, the device information and/or the content information may be appended to a content item request URL (e.g., contentitem.item/page/contentitem?devid=abc123&devnfo=A34r0). In some implementations, the device information and/or the content information may be encoded prior to being appended to the content item request URL. The requesting device information and/or the content information may be utilized by the content item selection system 108 to select third-party content items and/or a third-party content provider for a content item to be served with the requested resource and presented on a display of a client device 110.

In other implementations, the content item selection system 108 may select one of more content items from third-party content providers that direct the content item selection system 108 to place the third-party content provider's content items with the content of a particular content source. That is, some third-party content providers may prefer to have one or more content items selected to be served with content of a content source directly instead of based on selection criteria that may or may not result in the content item being selected and served with content of the content source. For instance, a third-party content provider having content items associated with video games may prefer to have the content items shown with a popular video game reviewing content source regardless of whether the content and/or the requesting device information would result in the content item being selected.

While the foregoing has provided an overview of a system 100 for selecting and serving content items to client devices 110 and/or directly placing content items with content of a content source, implementations for determining an ordered suggested content source set for a subject content provider will now be described in greater detail.

Referring to FIG. 2, the content item selection system 108 may include a content source suggestion system 210 for determining an ordered suggested content source set for a subject content provider and an impression database 220 storing impression data for one or more third-party content providers, categories of content providers, and/or the subject content provider. The impression data may include an identifier for a content provider and an identifier for a content source with which a content item of the content provider was displayed. In other instances, the impression database 220 may include other databases and/or data, such as traffic data (e.g., click data or organic traffic data), endorsement data, etc.

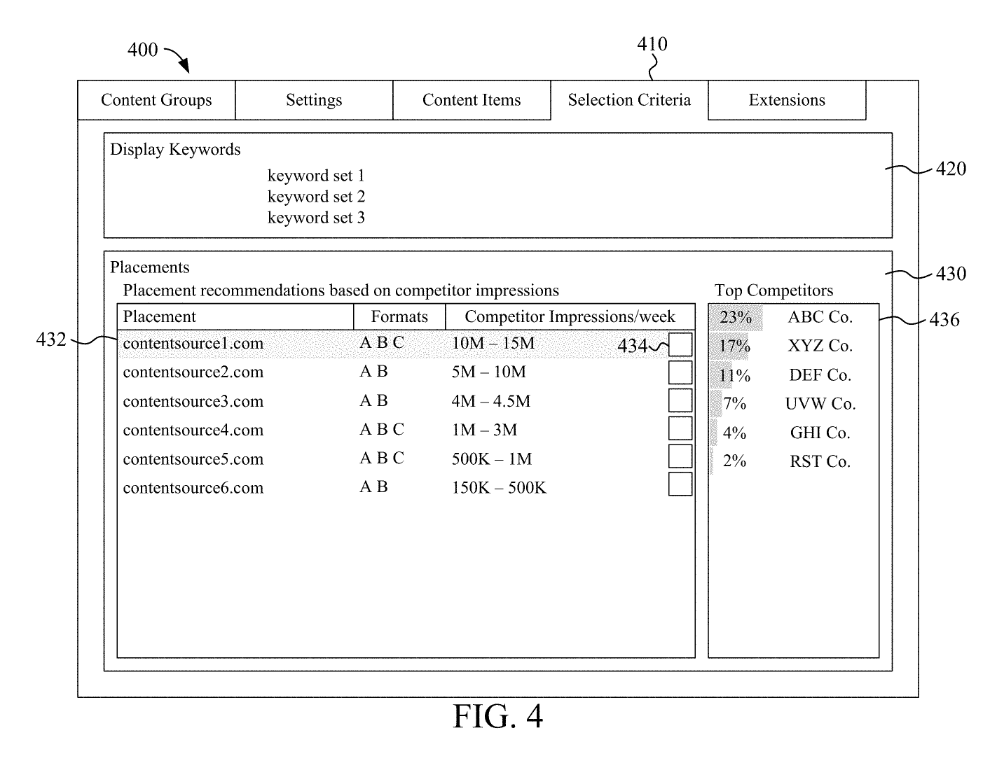

The content item selection system 108 may be accessible via an interface provided to a subject content provider to upload or specify one or more content items for the subject content providers, provide selection criteria for one or more content items, and/or manage direct placement of content items with content from one or more content sources. For instance, an implementation of an interface 400 shown in FIG. 4 for providing selection criteria (e.g., keywords) for one or more content items and/or managing direct placement of content items with content from one or more content sources may be provided for a subject content provider to manage how one or more content items are selected and/or served by the content item selection system 108.

Referring back to FIG. 2, the content item selection system 108 may receive a suggested content source request 202. The suggested content source request 202 may be received responsive to an interaction with the interface 400. For instance, responsive to a selection of a serving criteria tab of the interface 400, a client device of the subject content provider accessing the interface may determine a suggested content source request 202. In other implementations, the suggested content source request 202 may be determined by the client device of the subject content provider responsive to selection of a feature of the interface 400 (e.g., selection of a button to generate suggested content sources, etc.).

The content source suggestion system 210 may determine an ordered suggested content source set 204 to be transmitted to a client device of the subject content provider responsive to the suggested content source request 202. The determined ordered suggested content source set 204 may be an ordered list of content sources based on a total number of impressions, traffic, or user engagement/endorsement each of the content sources generated for each of the similar third-party content providers or categories of content providers on each of the potential content sources. That is, the content source having the largest number of impressions, traffic, or user engagement/endorsement for similar third-party content providers or categories of content providers may be the first listed content source. The content source having the second largest number of impressions, traffic, or user engagement/endorsement for similar third-party content providers or categories of content providers may be the second listed content source, etc. In some implementations, the ordered suggested content source set may exclude content sources that the subject content provider already directly places content items and/or receives impressions, traffic, or user engagement/endorsement from.

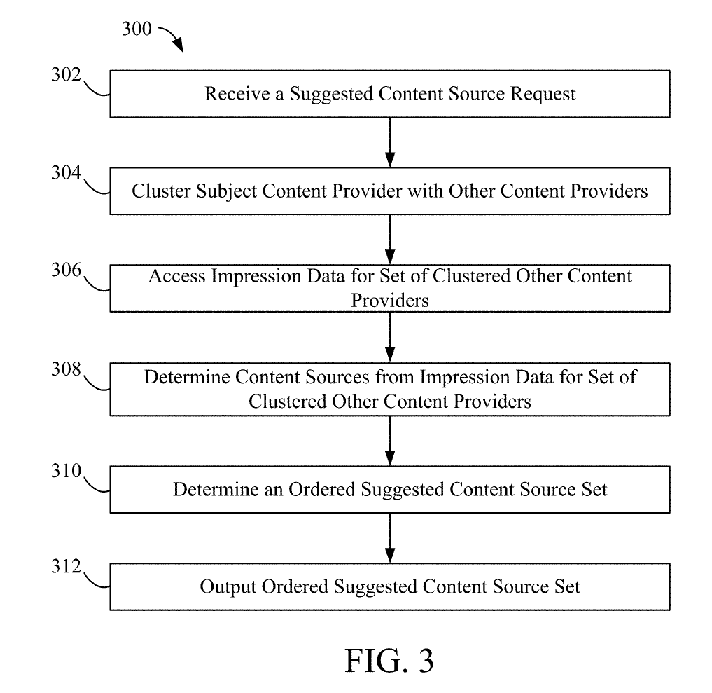

To determine the ordered suggested content source set, the content source suggestion system 210 may implement a process, such as process 300 of FIG. 3. In brief overview, as shown in FIG. 3, such a process includes receiving a suggested content source request (block 302), clustering a subject content provider with other content providers (block 304), retrieving impression data for a set of the other, clustered content provider (block 306), determining content sources from the retrieved impression data (block 308), determining an ordered set of content sources (block 310) and providing, as output, the ordered suggested content set (block 312).

Still referring to FIG. 3, and in greater detail, the process 300 includes receiving a suggested content source request (block 302). The suggested content source request may be received responsive to an interaction with the interface 400 of FIG. 4. For instance, responsive to a selection of a serving criteria tab of the interface 400, a client device of the subject content provider accessing the interface may determine a suggested content source request. In other implementations, the suggested content source request may be determined by the client device of the subject content provider responsive to selection of a feature of the interface 400 (e.g., selection of a button to generate suggested content sources, etc.).

The content source suggestion system 210 clusters a subject content provider with other content providers (block 304). In some implementations, the clustering of a subject content provider with other content providers may include clustering the subject content provider directly with similar third-party content providers or with categories of content providers. The clustering may be based on various criteria, such as by similar selection criteria for campaigns (e.g., similar keywords), similar entity size of the content providers, similar content item budgets, similar content sources for both the subject content provider and the other content providers, similar direct placement content sources, etc. The clustering may include using a K-nearest-neighbor (KNN) algorithm to cluster the subject content provider with similar third-party content providers or categories of content providers. That is, characteristics of the subject content provider, such as selection criteria for campaigns, entity size, content item budgets, direct placement content sources, etc. may be used to cluster the subject content provider with similar third-party content providers (e.g., XYZ Action Toy Co.) or categories of content providers (e.g., Toy content providers, Action Figure content providers, etc.) based on the similarity of the characteristics of the subject content provider to the characteristics of the similar third-party content providers or categories of content providers. In other implementations, K-means clustering, hierarchical agglomerative clustering algorithms, and/or other clustering algorithms may be used.

In some implementations, all content providers of the content item selection system 108 may be clustered into various clusters through an asynchronous process independent of the received suggested content source request. That is, a background process may be implemented by the content source suggestion system 210 to cluster each content provider into clusters at a predetermined periodic period, such as daily, weekly, etc. Each content provider may be associated with one or more cluster identifiers uniquely identifying one or more corresponding determined clusters based on the clustering algorithm. A set of cluster identifiers associated with a subject content provider may be stored in a data structure in a database. Thus, when a suggested content source request is received by the content source suggestion system 210, the content source suggestion system 210 may retrieve the set of one or more cluster identifiers for that subject content provider. Each cluster identifier may be associated with a set of one or more content provider identifiers or category identifiers of content providers for the cluster. That is, each cluster identifier may be mapped to a set of one or more content provider identifiers or category identifiers of content providers. In other implementations, the subject content provider may be associated with the set of one or more content provider identifiers or category identifiers of content providers directly.

In some implementations, the set of one or more content providers and/or category identifiers of content providers may be filtered. For instance, the set of one or more content provider identifiers or category identifiers of content providers may be filtered based on an entity size of the subject content provider relative to the other content providers such that only similarly sized content providers are included in the set of one or more content providers. In other instances, the size of a content item purchase for the subject content provider may be used to filter the content providers such that only content providers with similar purchase sizes may be included in the set of one or more content providers. In still other implementations, the amount of actual traffic for the subject content provider may be used to filter the content providers such that only content providers with similar amounts of actual traffic may be included in the set of one or more content providers. Still other filters may be applied to limit the set of content providers to those that are similar to the subject content provider.

Impression data for the determined set of clustered other content providers may be retrieved (block 306). The impression data for the determined set of clustered other content providers may include all impression data for each of the clustered other content providers or may be a subset of the impression data. That is, an impression database storing impression data for one or more content providers is queried to retrieve impression data based on the set of one or more content provider identifiers or category identifiers of content providers which are identified based on being directly associated with the subject content provider or based on a cluster identifier associated with the subject content provider. In some implementations, the impression data retrieved for the determined set of clustered other content providers may be a subset of the impression data stored in the impression database. For instance, the subset of impression data may be limited to a daily set of impression data, a weekly set of impression data, a monthly set of impression data, or a rolling window of impression data (e.g., last 7 days, last 14 days, last 30 days, last 60 days, last 90 days, etc.). In other instances, other data may be retrieved for the determined set of clustered other content providers, such as traffic data (e.g., click data or organic traffic data), user engagement/endorsement data, etc.

Content sources may be determined from the impression data for the set of clustered other content providers (block 308). In some implementations, the determination of content sources may include determining the content sources for the subject content provider and the content sources for the set of clustered other content providers. If the subject content provider already directly places content items with content of a content source common to those of the set of clustered other content providers, then the content source may be excluded from a suggested content source set as the subject content provider already directly places content item with content of that content source. That is, first impression data for the set of clustered other content providers may identify a content source for each impression of an impression record of the retrieved first impression data. A first set of content sources for the first impression data of the set of clustered other content providers may be determined based on the various impression records of the retrieved first impression data. Similarly, second impression data for the subject content provider may identify a content source for each impression of an impression record of the retrieved second impression data. A second set of content sources for the impression data of the subject content provider may be determined based on the various impression records of the retrieved second impression data. The first set of content sources may be compared to the second set of content sources and the content sources of the first set of content sources that are not included in the second set of content sources may be included as part of the suggested content source set. In some implementations, the second set of content sources may be based on a set of content sources specified by the subject content provider for direct placement of content items.

In other implementations, the content sources may be determined based on a percentage share of the impressions for the subject content provider being below a predetermined threshold. For instance, the content source suggestion system 210 may determine a total aggregate number of impressions for each content source based on the total number of impressions for each other content provider of the determined set of clustered other content providers and the total number of impressions for the subject content provider. That is, once the impression data for each of the determined set of clustered other content provider is retrieved, a total number of impressions for each content source may be determined. In addition, the total number of impressions for the subject content provider may be determined for each content source as well. The total number of impressions for each content source for the set of clustered other content providers can be aggregated with the total number of impressions for the subject content provider to determine the total aggregate number of impressions for each content source. A percentage share for the subject content provider of the total aggregate number of impressions for a content source may be determined based on the total number of impressions for the subject content provider and the aggregate number of impressions for the content source. If the percentage share is above a predetermined threshold, such as 10%, 5%, 1%, 0.05%, 0.01%, etc., then the content source may be excluded from a suggested content source set (i.e., the subject content provider receives a share of impressions greater than the predetermined threshold). If the percentage share is below (or equal to) the predetermined threshold, then the content source may be included for the suggested content source set. In other implementations, the predetermined threshold may be a ranking of the subject content provider relative to the other content providers. For instance, a percentage share for each of the set of clustered other content providers can be determined based on a corresponding total number of impressions the content source generated for each of the set of clustered other content providers and the aggregate number of impressions for the content source. A percentage share for the subject content provider can also be generated based on a corresponding total number of impressions the content source generated for the subject content provider and the aggregate number of impressions for the content source. The percentage shares of the aggregate number of impressions for the content source for the subject content provider and the other content providers may be ranked. If the percentage share of the subject content provider is above a predetermined rank, such as top 3, top 5, top 10, top 20, etc., then the content source may be excluded from the suggested content source set. If the percentage share of the subject content provider is below (or equal to) the predetermined rank, then the content source may be included in the suggested content source set.

In other implementations, the determination of content sources from impression data for the set of clustered other content providers (block 308) may be omitted such that all content sources are included in the determined ordered suggested content source set even if the subject content source provider is directly placing content items with content of the content source and/or receiving a large percentage of the impressions.

An ordered suggested content source set may be determined (block 310) based on the impression data and the determined set of clustered other content providers. That is, the total number of impressions for each of the set of clustered other content providers for each content source may be aggregated to determine a total aggregate other content provider number of impressions for each content source of the suggested content source set. The content sources of the suggested content source set may be sorted or ordered based on the corresponding total aggregate other content provider number of impressions for the content source. That is, the content source having the largest total aggregate other content provider number of impressions for similar third-party content providers may be the first listed content source in the ordered suggested content source set, the content source having the second largest total aggregate other content provider number of impressions for similar third-party content providers may be the second listed content source, etc. In some implementations, the ordered suggested content source set may thus include a name of the content source and the corresponding total aggregate other content provider number of impressions for the content source.

In some implementations, additional content may be included with the ordered suggested content source set. For instance, the ordered suggested content source set may include a category for the content source. In other implementations, the additional data may include the percentage share for each of the set of clustered other content providers and/or for a subset of the clustered other content providers. For instance, the additional data may include the names of the top 3, top 5, top 10, etc. clustered other content providers with the highest percentage share.

The ordered suggested content source set may be outputted (block 312) to a client device responsive to the received suggested content source request. In some implementations, the ordered suggested content source set may be output as an ordered data set to be displayed via an interface, such as interface 400.

In some implementations, traffic data and/or user engagement/endorsement data may be used, either in addition to or in lieu of impression data. Furthermore, the other content providers may be grouped into categories such that specific content providers are not specifically specified. In still further implementations, content sources may be grouped together such that the ordered suggested content source set may be an ordered suggested set of groups of content sources.

FIG. 4 depicts an implementation of an interface 400 for interacting with the content item selection system 108. The interface 400 may include several tabs 410 for selecting and displaying different portions of the interface 400, such as a content groups portion, a settings portion, a content items portion, a selection criteria portion, an extensions portion, etc. In some implementations, the selection of the selection criteria tab may cause the client device to send a suggested content source request to the suggested content source system 210 of the content item selection system 108. In other implementations, the interface 400 may include a selectable feature, such as a button or other selection feature, that causes the client device to send a suggested content source request to the suggested content source system 210 of the content item selection system 108.

The interface 400 may further include a selection criteria region 420 and a direct placement region 430. The selection criteria region 420 may display the various selection criteria, such as keywords, the subject content provider has designated for a content item to be selected for. For instance, a content item related to a particular action figure may have the keywords of “keyword set 1,” “keyword set 2,” and “keyword set 3” designated by a subject content provider for selecting and serving the content item.

As shown in FIG. 4, the interface 400 also includes a direct placement region 430 for displaying any content sources designated for directly placing the content item. The direct placement region includes a suggested content source portion 432 for displaying the content sources of the ordered suggested content source set. For instance, the suggested content source portion 432 displays six content sources sorted by the total aggregate other content provider number of impressions for similar third-party content providers. Thus, a subject content provider accessing the interface 400 may view the total impressions other content providers receive via a particular content source and may determine whether the subject content provider should pursue direct content placement with that particular content source based on the number of impressions the other content providers receive. In some implementations, a selection feature 434 may be provided to allow a user of the interface 400 to select a content source for direct placement of a content item.

In some implementations, the direct placements region 430 also includes an additional data feature 436. The additional data feature may be a separate portion of the interface 400 displaying the additional data, such as the additional data feature 436, or the additional data feature may be a pop-up or mouse-over feature that is displayed responsive to a selection or mouse-over of a content source of the suggested content source portion 432. The additional data feature 436 displays one or more aspects of the additional data included with the ordered suggested content source set. The additional data feature 436 displays the top other content providers for a content source and also providers the percentage share for that other content provider of the total aggregate other content provider number of impressions for similar third-party content providers. For instance, the content source “contentsource1.com” is shown selected with the additional data feature 436 populated with the corresponding top other content providers and their respective percentage share of the total aggregate other content provider number of impressions for similar third-party content providers.

In other implementations, the content sources may be grouped into categories of content sources for a subject content provider to select from. The other content providers may also be grouped into categories of other content providers.

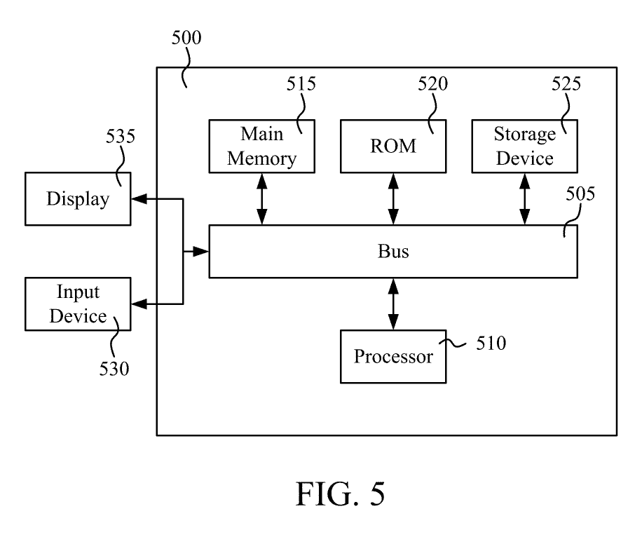

FIG. 5 is a block diagram of a computer system 500 that can be used to implement the client device 110, content item selection system 108, third-party content server 102, resource server 104, suggested content source system 210, etc. The computing system 500 includes a bus 505 or other communication component for communicating information and a processor 510 coupled to the bus 505 for processing information. The computing system 500 can also include one or more processors 510 coupled to the bus for processing information. The computing system 500 also includes main memory 515, such as a RAM or other dynamic storage device, coupled to the bus 505 for storing information, and instructions to be executed by the processor 510. Main memory 515 can also be used for storing position information, temporary variables, or other intermediate information during execution of instructions by the processor 510. The computing system 500 may further include a ROM 520 or other static storage device coupled to the bus 505 for storing static information and instructions for the processor 510. A storage device 525, such as a solid state device, magnetic disk or optical disk, is coupled to the bus 505 for persistently storing information and instructions. Computing device 500 may include, but is not limited to, digital computers, such as laptops, desktops, workstations, personal digital assistants, servers, blade servers, mainframes, cellular telephones, smart phones, mobile computing devices (e.g., a notepad, e-reader, etc.) etc.

The computing system 500 may be coupled via the bus 505 to a display 535, such as a Liquid Crystal Display (LCD), Thin-Film-Transistor LCD (TFT), an Organic Light Emitting Diode (OLED) display, LED display, Electronic Paper display, Plasma Display Panel (PDP), and/or other display, etc., for displaying information to a user. An input device 530, such as a keyboard including alphanumeric and other keys, may be coupled to the bus 505 for communicating information and command selections to the processor 510. In another implementation, the input device 530 may be integrated with the display 535, such as in a touch screen display. The input device 530 can include a cursor control, such as a mouse, a trackball, or cursor direction keys, for communicating direction information and command selections to the processor 510 and for controlling cursor movement on the display 535.

According to various implementations, the processes and/or methods described herein can be implemented by the computing system 500 in response to the processor 510 executing an arrangement of instructions contained in main memory 515. Such instructions can be read into main memory 515 from another computer-readable medium, such as the storage device 525. Execution of the arrangement of instructions contained in main memory 515 causes the computing system 500 to perform the illustrative processes and/or method steps described herein. One or more processors in a multi-processing arrangement may also be employed to execute the instructions contained in main memory 515. In alternative implementations, hard-wired circuitry may be used in place of or in combination with software instructions to effect illustrative implementations. Thus, implementations are not limited to any specific combination of hardware circuitry and software.

Although an implementation of a computing system 500 has been described in reference to FIG. 5, implementations of the subject matter and the functional operations described in this specification can be implemented in other types of digital electronic circuitry, or in computer software, firmware, or hardware, including the structures disclosed in this specification and their structural equivalents, or in combinations of one or more of them.

Implementations of the subject matter and the operations described in this specification can be implemented in digital electronic circuitry, or in computer software embodied on a tangible medium, firmware, or hardware, including the structures disclosed in this specification and their structural equivalents, or in combinations of one or more of them. The subject matter described in this specification can be implemented as one or more computer programs, i.e., one or more modules of computer program instructions, encoded on one or more computer storage media for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate components or media (e.g., multiple CDs, disks, or other storage devices). Accordingly, the computer storage medium is both tangible and non-transitory.

The operations described in this specification can be performed by a data processing apparatus on data stored on one or more computer-readable storage devices or received from other sources.

The terms “data processing apparatus,” “computing device,” or “processing circuit” encompass all kinds of apparatus, devices, and machines for processing data, including a programmable processor, a computer, a system on a chip, or multiple ones, a portion of a programmed processor, or combinations of the foregoing. The apparatus can include special purpose logic circuitry, e.g., an FPGA or an ASIC. The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

Processors suitable for the execution of a computer program include, for instance, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including, for instance, semiconductor memory devices, e.g., EPROM, EEPROM, and flash memory devices; magnetic disks, e.g., internal hard disks or removable disks; magneto-optical disks; and CD-ROM and DVD disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD monitor, for displaying information to the user and a keyboard and a pointing device, e.g., a mouse or a trackball, by which the user can provide input to the computer. Other kinds of devices can be used to provide for interaction with a user as well; for instance, feedback provided to the user can be any form of sensory feedback, e.g., visual feedback, auditory feedback, or tactile feedback; and input from the user can be received in any form, including acoustic, speech, or tactile input.

While this specification contains many specific implementation details, these should not be construed as limitations on the scope of what may be claimed, but rather as descriptions of features specific to particular implementations. Certain features described in this specification in the context of separate implementations can also be implemented in combination in a single implementation. Conversely, various features described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated in a single software product or packaged into multiple software products embodied on tangible media.

References to “or” may be construed as inclusive so that any terms described using “or” may indicate any of a single, more than one, and all of the described terms.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

The claims should not be read as limited to the described order or elements unless stated to that effect. It should be understood that various changes in form and detail may be made by one of ordinary skill in the art without departing from the spirit and scope of the appended claims. All implementations that come within the spirit and scope of the following claims and equivalents thereto are claimed.

1. A method comprising:
receiving, by one or more processors and from a first content provider, a suggested publisher request from a client device that indicates a request for a set of one or more suggested publishers to publish content from the first content provider;
identifying that the content relates to a first subject;
identifying one or more other content providers other than the first content provider that provide different content relating to the first subject;
accessing, using the one or more processors, impression data for the first content provider and the one or more other content providers;
determining, using the one or more processors and the accessed impression data for the one or more other content providers, a set of publishers that have previously published content for the one or more other content providers;
determining, for each of the publishers in the set of publishers, a percentage share of total impressions provided by the publisher that would be provided to the first content provider, wherein the percentage share of total impressions provided to the first content provider is determined as a ratio of a number of impressions provided to the first content provider relative to an aggregate number of impressions provided to the one or more other content providers and the first content provider;
excluding one or more publishers from the set of publishers based on the percentage share of total impressions that would be provided to the first content provider by the one or more publishers exceeding a predetermined threshold;
ranking, using the one or more processors and the accessed impression data for the one or more other content providers, the publishers remaining in the set of publishers after the excluding based on a total number of impressions provided by each of the publishers to the one or more other content providers; and
outputting, in response to receiving the suggested publisher request, the ranked publisher set to the client device for display.

2. The method of claim 1, further comprising identifying categories of content providers.

3. The method of claim 1 further comprising:
filtering, using the one or more processors, the one or more other content providers based on an entity size of the first content provider.

4. The method of claim 1 further comprising:
filtering, using the one or more processors, the one or more other content providers based on a content item purchase size of the first content provider.

5. The method of claim 1, wherein the ranked publisher set comprises additional data associated with a publisher of the ranked publisher set.

6. (canceled)

7. The method of claim 1, wherein determining the set of publishers comprises excluding a publisher for which the first content provider is directly placing a content item.

8. The method of claim 1, wherein a publisher of the set of publishers is one of: a media provider, a mobile application provider or developer, a web page, or a website.

9. A system comprising:
one or more processors; and one or more storage devices storing instructions that, when executed by the one or more processors, cause the one or more processors to perform operations comprising:
identifying a first content provider that provides content relating to a first subject;
identifying one or more other content providers distinct from the first content provider that provide different content relating to the first subject;
accessing impression data for the first content provider and the one or more other content providers;
determining, using the accessed impression data for the one or more other content providers, a set of publishers that have previously published content for the one or more other content providers;
determining, for each of the publishers in the set of publishers, a percentage share of total impressions provided by the publisher that would be provided to the first content provider, wherein the percentage share of total impressions provided to the first content provider is determined as a ratio of a number of impressions provided to the first content provider relative to an aggregate number of impressions provided to the one or more other content providers and the first content provider;
excluding one or more publishers from the set of publishers based on the percentage share of total impressions that would be provided to the first content provider by the one or more publishers exceeding a predetermined threshold;
ranking, using the accessed impression data for the one or more other content providers, the publishers remaining in the set of publishers after the excluding based on a total number of impressions provided by each of the publishers to the one or more other content providers; and
outputting, in response to receiving a suggested publisher request from a client device that indicates a request for a set of one or more suggested publishers to publish content from the first content provider, the ranked publisher set to the client device for display.

10. The system of claim 9, wherein ranking the publishers in the set of publishers comprises:
determining, for each of the one or more other content providers, a total aggregate number of impressions for each publisher based on the accessed impression data for the one or more other content providers; and
ranking the publishers in the set of publishers based on the determined total aggregate number of impressions for each publisher.

11. The system of claim 9, the operations further comprising identifying categories of content providers.

12. The system of claim 9, wherein the ranked publisher set comprises additional data associated with a publisher.

13. (canceled)

14. The system of claim 9, the operations further comprising:
filtering the one or more other content providers based on an entity size or a content item purchase size of the first content provider.

15. The system of claim 9, wherein a publisher of the ranked publisher set is one of: a media provider, a mobile application provider or developer, a web page, or a website.

16. The system of claim 9, the operations further comprising:
storing a set of cluster identifiers associated with the first content provider in a data structure, the set of cluster identifiers determined based on the clustering of the first content provider with the set of one or more other content providers.

17. A computer readable storage device storing instructions that, when executed by one or more processors, cause the one or more processors to perform operations comprising:
receiving, from a first content provider, a suggested publisher request from a client device that indicates a request for a set of one or more suggested publishers to publish content from the first content provider;
identifying that the content relates to a first subject;
identifying one or more other content providers other than the first content provider that provide different content relating to the first subject;
accessing impression data for the first content provider and the one or more other content providers;
determining a set of publishers that have previously published content for the one or more other content providers, wherein the determining is based on the accessed impression data for the one or more other content providers;
determining, for each of the publishers in the set of publishers, a percentage share of total impressions provided by the publisher that would be provided to the first content provider, wherein the percentage share of total impressions provided to the first content provider is determined as a ratio of a number of impressions provided to the first content provider relative to an aggregate number of impressions provided to the one or more other content providers and the first content provider;
excluding one or more publishers from the set of publishers based on the percentage share of total impressions that would be provided to the first content provider by the one or more publishers exceeding a predetermined threshold;
ranking the publishers remaining in the set of publishers after the excluding based on a total number of impressions provided by each of the publishers to the one or more other content providers; and
outputting, in response to receiving the suggested publisher request, the ranked publisher set to the client device for display.

18. The computer readable storage device of claim 17, wherein a publisher of the ranked publisher set is one of: a media provider, a mobile application provider or developer, a web page, or a website.

19. (canceled)

20. The computer readable storage device of claim 17, the operations further comprising:
filtering the one or more other content providers based on an entity size or a content item purchase size of the first content provider.
